(19) United States
(12) Patent Application Publication
(10) Pub. No.: US 2014/0189806 A1
(43) Pub. Date: Jul. 3, 2014

(54) Wireless Network Linking System and Method of Obtaining Access Right of Network Thereof

(71) Applicants: MITAC INTERNATIONAL CORP., Kuei San Township (TW); MITAC RESEARCH (SHANGHAI) LTD., Shanghai (CN)

(72) Inventor: Wei-Chiang Cho, Taoyuan City (TW)

(21) Appl. No.: 13/799,284

(22) Filed: Mar. 13, 2013

(30) Foreign Application Priority Data
Dec. 27, 2012 (CN) 201210580570.3

(51) Int. Cl. H04W 12/08

(52) U.S. Cl. CPC H04W 12/08
USPC 726/4

(57) ABSTRACT

A wireless network linking system and a method of obtaining access right of network thereof The method includes following steps: sending a wireless access signal by a client with wireless network access function; receiving the wireless access signal and deciding the location of the client according to a signal strength of the wireless access signal by a server; and providing a wireless access point service to the client by the server, thereby providing the client the permission of accessing network resources if the location of the client is corresponding to a specific region.

### CROSS-REFERENCE TO RELATED APPLICATION

This application claims the benefit of China Patent Application No. 201210580570.3 filed on Dec. 27, 2012, in the China Intellectual Property Office, the disclosure of which is incorporated herein in its entirety by reference.

### FIELD OF THE INVENTION

The present invention relates to a wireless network linking system and a method of obtaining an access right of a network thereof, in particular to the wireless network linking system and the method of obtaining an access right of a network capable of obtaining a permission of logging on a network by an indoor positioning system (IPS) without requiring entering a password manually.

### BACKGROUND OF THE INVENTION

As science and technology advance rapidly, mobile positioning services catch increasing attention. At present, the most popular mobile positioning service is the global positioning system (GPS) which has been used extensively in many areas. Indoor positioning system (IPS) services have huge market and business opportunity, but providing such services requires technologies different from outdoor positioning technologies and the ascendant instant positioning system can meet the technical requirements for indoor environment.

The major limitation of GPS technologies resides on the requirement of maintaining a light of sight (LOS) environment with a satellite system. In an indoor environment or a building, wireless signals cannot be transmitted directly with a client's equipment, so that the expected accuracy of positioning cannot be achieved or the positioning may be even invalid. Although some manufacturers attempted to apply the global positioning system in an indoor positioning system (IPS), the cost is very high. Various different indoor positioning system (IPS) technologies such as the infrared (IR) positioning technology, global positioning system (GPS), radio frequency (RF) positioning technology and radio frequency identification (RFID) positioning system have been developed.

In addition, more and more people use the wireless network indoors, regardless of using it in a company or at home. If a guest pays a visit and needs to use the network, the server in the office or at home can provide the guest to access network resources. However, the guest requiring the access of wireless network resources in the office or at a home has to enter a password manually through a network management people or someone familiar with the network setting operation before the guest's computer can obtain the permission to access the wireless network. Obviously, such application is inconvenient. On the other hand, if no password is set for the network access, the network resources may be stolen.

In view of the aforementioned problem, the inventor of the present invention integrated an indoor positioning system (IPS) technology with a wireless network transmission technology to achieve the effect of obtaining the permission of accessing a wireless network quickly and safely.

### SUMMARY OF THE INVENTION

In view of the shortcomings of the prior art, it is a primary objective of the present invention to provide a wireless network linking system and a method of obtaining an access right of a network thereof, so as to overcome the problem of requiring users to enter a password manually before they can obtain the access right of a wireless network.

To achieve the foregoing objective, the present invention provides a wireless network linking system, comprising a client and a server. The client has a wireless network access function capable of selectively sending out a wireless access signal. The server receives the wireless access signal and determines the location of the client according to the signal strength of the wireless access signal. If the location of the client corresponds to a specific region, the server provides a wireless access point service to the client and allows the client to obtain the permission of accessing network resources.

Preferably, if the location of the client does not correspond to the specific region, the server sends a prompt message to the client.

Preferably, when the server receives the wireless access signal, the server determines the client to access the network resources or not according to whether the signal strength is greater than a threshold value, the server provides the wireless access point service to the client if the signal strength is greater than the threshold value, and the server sends the prompt message to the client if the signal strength is smaller than the threshold value.

Preferably, the wireless access signal transmitted from the client includes a positioning signal, and the server determines the location of the client according to the signal strength of the positioning signal.

Preferably, the server includes a radio index map saved therein, and the radio index map comprises signal strength information of a plurality of regions, and the server compares the signal strength of the positioning signal with the signal strength information of each region, and if the server determines that the location of the client corresponds to a specific one of the regions, the server provides the wireless access point service to the client.

Preferably, the client has a radio frequency identification (RFID) transmission function for sending out the positioning signal, and the server has a radio frequency identification (RFID) receiving function for receiving and analyzing the positioning signal.

To achieve the foregoing objective, the present invention provides a method of obtaining an access right of a network, applied to a wireless network linking system, comprising the steps of: sending out a wireless access signal by a client with a wireless network access function; receiving the wireless access signal and determining the location of the client according to a signal strength of the wireless access signal by a server; and providing a wireless access point service to the client by the server to allow the client to obtain a permission of accessing network resources, if the location of the client corresponds to a specific region.

The wireless network linking system and the method of obtaining an access right of a network thereof in accordance with the present invention can determine the location of the client according to the wireless signal strength at different regions where the client is situated through the indoor positioning system (IPS) technology, so as to determine whether to provide a wireless network access service to the client. Therefore, the users no longer need to input a password manually before obtaining the permission of accessing a wireless network, not only providing convenience to the use, but also offering a better protection of the network security.

### BRIEF DESCRIPTION OF THE DRAWINGS

FIG. 1 is a schematic view of a wireless network linking system of the present invention;

FIG. 2 is a flow chart of a method of obtaining an access right of a network in accordance with the present invention; and

FIG. 3 is a flow chart of a wireless network linking system and a method of obtaining an access right of a network thereof in accordance with a preferred embodiment of the present invention.

### DESCRIPTION OF THE PREFERRED EMBODIMENTS

The technical characteristics of the present invention will become apparent with the detailed description of the preferred embodiments accompanied with the illustration of related drawings as follows. It is noteworthy that same numerals are used for representing the same respective elements in the drawings, and the drawings are provided for the purpose of illustrating the invention, but not intended for limiting the scope of the invention.

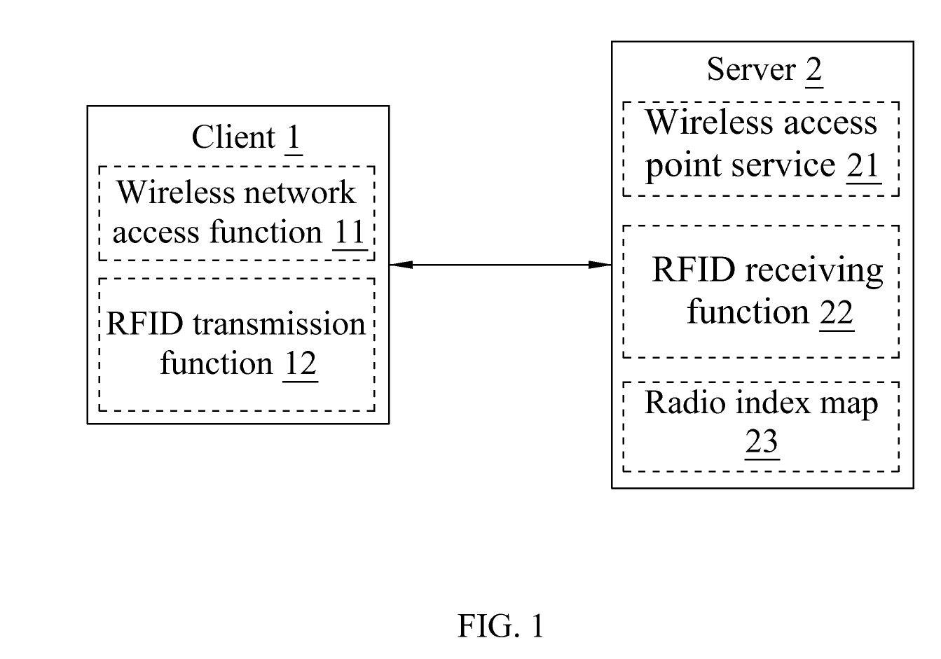

With reference to FIG. 1 for a schematic view of a wireless network linking system of the present invention, the wireless network linking system comprises a client 1 and a server 2. The client 1 is a device capable of connecting a wireless network such as a personal computer, a notebook computer, a tablet PC, a Smartphone, or a personal digital assistant. The server 2 can be a servo host used in a company or at home and installed at a fixed point, and the client 1 can be held by a user such as a customer or a guest. If the client 1 is situated within the same range or the same building of the server 2, the client 1 may search for the server 2 to access wireless network resources.

The client 1 can have a wireless network card and a radio frequency identification (RFID) interface card to provide the client 1 a wireless network access function 11 and a radio frequency identification (RFID) transmission function 12. The client 1 can selectively send out a wireless access signal through the wireless network access function 11 and selectively sends out a radio frequency signal through the radio frequency identification (RFID) transmission function 12, similarly to the positioning signal of the present invention. If the client 1 wants to transmit the wireless access signal and the positioning signal to a specific device, the client 1 can mix and load the positioning signal to the wireless access signal before sending out the signal, or transmit the wireless access signal and the positioning signal simultaneously, and the present invention is not limited to the aforementioned arrangements.

The server 2 can provide a wireless access point service 21, and has a radio frequency identification (RFID) receiving function 22 and stores a radio index map 23. The radio frequency identification (RFID) receiving function 22 allows the server 2 to analyze the positioning signal sent by the client 1. Wherein, the radio index map 23 can be created according to the signal strength information detected from different regions, so that the radio index map 23 can be divided into a plurality of regions and includes the signal strength information of each region.

Wherein, when the client 1 sends out a wireless access signal including the positioning signal to the server 2, the server 2 can determine the location of the client 1 according to the signal strength of the wireless access signal. If the location of the client 1 corresponds to one of the specific regions, the server 2 will provide the wireless access point service 21 to the client 1 to allow the client 1 to obtain a permission of accessing network resources, such as browsing a webpage. If the location of the client 1 is not in one of the specific regions, the server 2 will send a prompt message to the client 1 to notify the holder of the client 1 and lock the client 1 from accessing of the wireless network of the server 2. Wherein, the server 2 can determine whether or not to provide the wireless network access without determining whether the client 1 is situated in the specific region. The server 2 can determine whether the signal strength of the wireless access signal is greater than a threshold value when the wireless access signal transmitted from the client 1 is received in order to determine whether or not to provide the client 1 to access the network resources. If the signal strength is greater than the threshold value, the server 2 will provide the wireless access point service 21 to the client 1, and if the signal strength is smaller than the threshold value, then the prompt message will be sent to the client 1.

Wherein, the server 2 mainly uses the radio frequency identification (RFID) receiving function 22 to analyze the positioning signal included in the wireless access signal, and then the signal strength of the positioning signal is used to determine the location of the client 1. If the client 1 does not mix the wireless access signal with the positioning signal but sends both wireless access signal and positioning signal simultaneously to the server 2, the server 2 will receive the positioning signal directly and compare the signal strength of the positioning signal for the determination. In addition, the server 2 mainly compares the signal strength with the signal strength information of each region in the radio index map 23. If the server 2 determines that the location of the client 1 corresponds to one of the specific regions, the server 2 will provide the wireless access point service 21 to the client 1. The positioning method used in the present invention is not limited to RFID only, but it can be infrared (IR), GPS and any other equivalent methods.

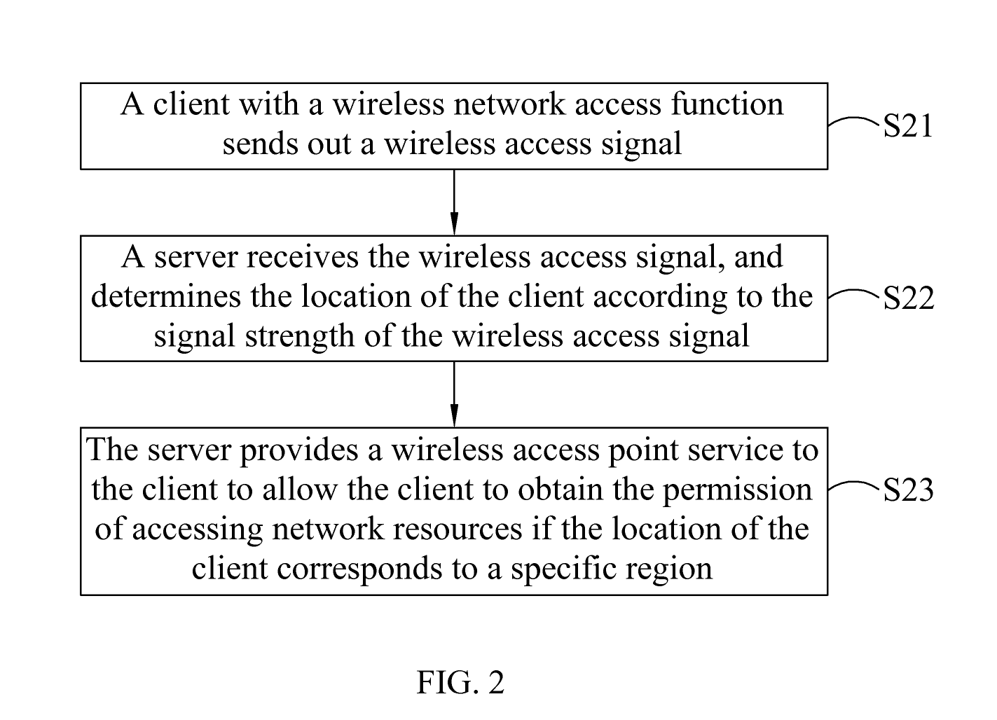

With reference to FIG. 2 for a flow chart of a method of obtaining an access right of a network in accordance with the present invention, the method is applied to a wireless network linking system as shown in FIG. 1, and the method comprises the following steps:

S21: A client with a wireless network access function sends out a wireless access signal.

S22: A server receives the wireless access signal, and determines the location of the client according to the signal strength of the wireless access signal.

S23: The server provides a wireless access point service to the client to allow the client to obtain the permission of accessing network resources if the location of the client corresponds to a specific region.

In addition, the method further comprises the step of sending a prompt message to the client by the server if the location of the client does not correspond to any specific region. More specifically, the server compares the signal strength of the positioning signal with the signal strength information of each region included in the radio index map saved in the server; and the server determines whether the location of the client corresponds to one of the specific regions; if yes, then the server will provide the wireless access point service to the client.

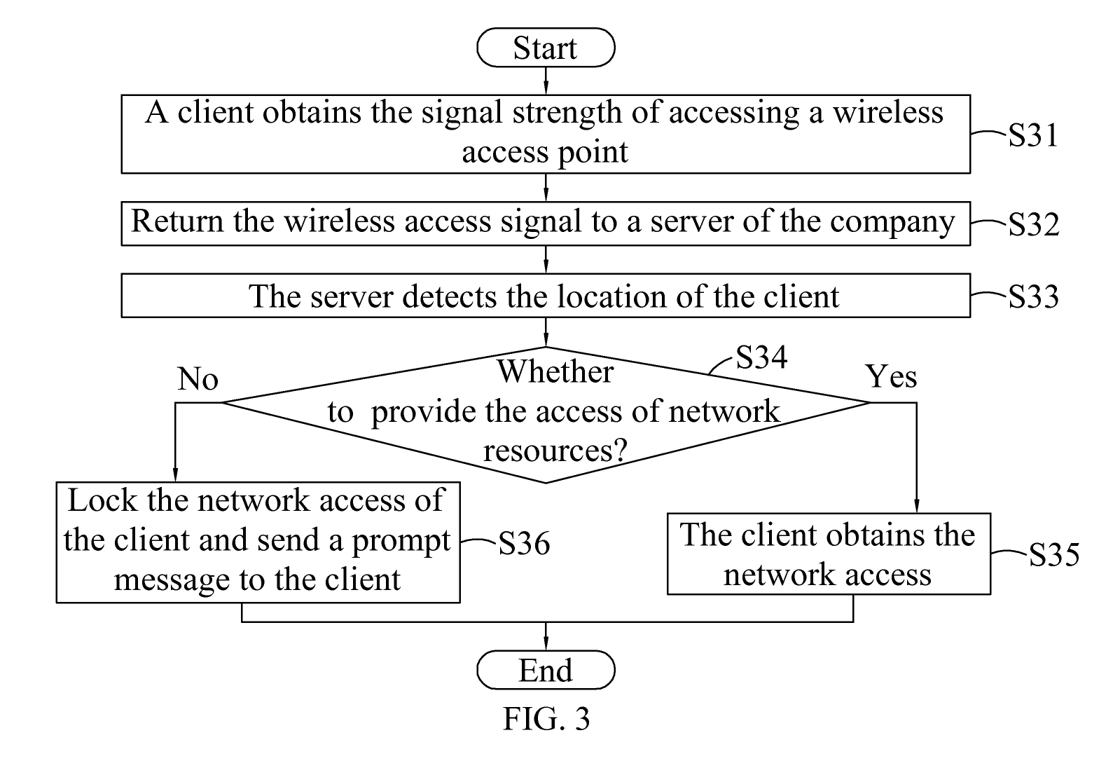

With reference to FIG. 3 for a flow chart of a wireless network linking system and a method of obtaining an access right of a network thereof in accordance with a preferred embodiment of the present invention, the flow chart starts from the step S31, and the whole procedure of the flow chart is described as follows:

S31: A user carries a client to a company and sends out a wireless access signal to obtain the signal strength of accessing a wireless access point.

S32: The client sends the wireless access signal back to a server installed in the company.

S33: The server detects the location of the client according to the signal strength of the wireless access signal.

S34: The server compares the signal strength with the signal strength information of each region saved in the company to determine whether to provide the access of network resources; if yes, then go to the step S35, or else go to the step S36.

S35: If the server determines that the client is situated in one of the specific regions of the company, the server will grant the permission of accessing wireless network resources to the client and allow the client to access the network.

S36: If the server determines that the client is not situated in any one of the specific regions of the company, the server will lock the wireless network access of the client and send a prompt message to the client to notify the user that this region does not provide access of the network resources.

In summation of the description above, the wireless network linking system and the method of obtaining an access right of a network thereof in accordance with the present invention allows the client to obtain the permission of accessing a wireless network quickly by the indoor positioning system (IPS) without requiring entering a password manually, not only providing a convenient application, but also offers a high network security.

What is claimed is:

1. A wireless network linking system, comprising:
a client, with a wireless network access function, and capable of selectively sending out a wireless access signal; and
a server, receiving the wireless access signal, and determining the location of the client according to a signal strength of the wireless access signal, such that if the location of the client corresponds to a specific region, the server provides a wireless access point service to the client to allow the client to obtain a permission of accessing network resources.

2. The wireless network linking system of claim 1, wherein if the location of the client does not correspond to the specific region, the server sends a prompt message to the client.

3. The wireless network linking system of claim 2, wherein when the server receives the wireless access signal, the server determines the client to access the network resources or not according to whether the signal strength is greater than a threshold value, the server provides the wireless access point service to the client if the signal strength is greater than the threshold value, and the server sends the prompt message to the client if the signal strength is smaller than the threshold value.

4. The wireless network linking system of claim 1, wherein the wireless access signal transmitted from the client includes a positioning signal, and the server determines the location of the client according to the signal strength of the positioning signal.

5. The wireless network linking system of claim 4, wherein the server includes a radio index map saved therein, and the radio index map comprises signal strength information of a plurality of regions, and the server compares the signal strength of the positioning signal with the signal strength information of each region, and if the server determines that the location of the client corresponds to a specific one of the regions, the server provides the wireless access point service to the client.

6. The wireless network linking system of claim 5, wherein the client has a radio frequency identification (RFID) transmission function for sending out the positioning signal, and the server has a radio frequency identification (RFID) receiving function for receiving and analyzing the positioning signal.

7. A method of obtaining an access right of a network, applied to a wireless network linking system, comprising the steps of:
sending out a wireless access signal by a client with a wireless network access function;
receiving the wireless access signal and determining the location of the client according to a signal strength of the wireless access signal by a server; and
providing a wireless access point service to the client by the server to allow the client to obtain a permission of accessing network resources, if the location of the client corresponds to a specific region.

8. The method of obtaining an access right of a network according to claim 7, further comprising the step of:
sending a prompt message to the client by the server, if the location of the client does not correspond to the specific region.

9. The method of obtaining an access right of a network according to claim 8, wherein when the server receives the wireless access signal, the server determines the client to access the network resources or not according to whether the signal strength is greater than a threshold value, the server provides the wireless access point service to the client if the signal strength is greater than the threshold value, and the server sends the prompt message to the client if the signal strength is smaller than the threshold value.

10. The method of obtaining an access right of a network according to claim 7, wherein the wireless access signal transmitted from the client includes a positioning signal, and the server determines the location of the client according to the signal strength of the positioning signal.

11. The method of obtaining an access right of a network according to claim 10, wherein the server has a radio index map saved therein, and the radio index map includes signal strength information of a plurality of regions, and the method further comprising the steps of:
comparing the signal strength of the positioning signal with the signal strength information of each region by the server; and
determining whether the location of the client corresponds to one of the specific regions by the server; and providing the wireless access point service to the client if the location of the client corresponds to one of the specific regions.

12. The method of obtaining an access right of a network according to claim 11, wherein the client has a radio frequency identification (RFID) transmission function for sending out the positioning signal, and the server has a radio frequency identification (RFID) receiving function for receiving and analyzing the positioning signal.
